(19) United States
(12) Patent Application Publication
(10) Pub. No.: US 2006/0205832 A1
(43) Pub. Date: Sep. 14, 2006

(54) Polymer-ionomer blends and foams thereof

(76) Inventor: David M. Dean, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/371,406

(22) Filed: Mar. 9, 2006

Related U.S. Application Data
(60) Provisional application No. 60/660,374, filed on Mar. 9, 2005.

(51) Int. Cl. C08J 9/00

(52) U.S. Cl. 521/134

(57) ABSTRACT

A foam comprising a foamed polymer-ionomer blend comprising: (a) at least one thermoplastic polymer selected from the group consisting of polyethylene and copolymers thereof, polypropylene and copolymers thereof, polybutene-1, poly(4-methylpentene-1), polystyrene and copolymers thereof, and (b) an ionomer resin comprising at least one direct or graft terpolymer prepared from: (1) ethylene, (2) α,β-ethylenically unsaturated carboxylic acid having from 3 to 8 carbon atoms, and (3) softening comonomer selected from the group consisting of (A) vinyl esters of aliphatic carboxylic acids wherein the aliphatic carboxylic acid has from 2 to 10 carbon atoms, (B) alkyl vinyl ethers wherein the alkyl group contains from 1 to 10 carbon atoms, and (C) alkyl acrylates or alkyl methacrylates wherein the alkyl group contains from 1 to 10 carbon atoms. The ionomer resin contains acid groups derived from the α,β-ethylenically unsaturated carboxylic acid that are at least partially neutralized with mono- or divalent metal ions. The blend has a flexural modulus of less than about 20,000 psi and a melt tension of greater than about 10 cN at 220° C. The foam cell compositions are suitable for use in multilayer structures and articles such as diapers, adult incontinence pads, and sanitary napkins.

### PRIORITY

This application claims the benefit of U.S. Provisional Application No. 60/660,374, filed Mar. 9, 2005, which is incorporated herein by reference.

### FIELD OF THE INVENTION

This invention relates to blends of ionomers and thermoplastic polymers with melt strength and modulus properties suitable for preparing extrudable open cell foams.

### BACKGROUND OF THE INVENTION

Open cell polymeric foams have considerable commercial interest for use in absorbent articles such as disposable diapers, adult incontinence pads and briefs, and sanitary napkins. There is considerable art in the area of open cell foams for these uses. For example, U.S. Pat. Nos. 5,650,222, 5,741,581 and 5,744,506 disclose low density absorbent foams made by polymerizing high internal phase emulsions where the volume to weight ratio of the water phase to the oil phase is in the range of from about 55:1 to about 100:1. Open cell foams based on polyolefins are particularly useful in these applications because of their outstanding chemical resistance and recyclability.

Polyolefin open cell foams are often lightly crosslinked in order to control and stabilize the size of the foam cells. Foams can be crosslinked by irradiation or by free-radical catalysts, e.g. peroxides. Ionomers are useful as components of open cell foams. Ionomers are copolymers having ionizable comonomers that are at least partially neutralized (ionized) to yield carboxylate salts. Normally they are prepared by copolymerization of ethylene with small amounts of an unsaturated carboxylic acid, followed by neutralization of some portion of the acid groups. The ionized groups can act as meltable crosslinks. For example, U.S. Pat. No. 4,102,829 discloses low density extruded foams prepared from a mixture of from about 5 to 65% polyolefin and from about 35 to 95% ionomer, the ionomer being a zinc salt.

U.S. Pat. No. 4,091,136 discloses a fine closed cell foam produced by extrusion in rod form of a foamable mixture of polyolefin and a foaming agent together with an ethylene/methacrylic acid copolymer based ionomer resin.

In U.S. Pat. No. 4,102,829, there is disclosed a foamed thermoplastic mixture of ionomers and polyolefin polymer produced by extruding the mix together with a volatile blowing agent at elevated temperature and pressure. The foams are said to have a good balance of properties, and are indicated to be useful as insulation covering on pipes for air conditioning.

Japanese Laid Open Patent Application H10-279724/1998 discloses a foam made from 0 to 50 parts by weight of polyolefin resin and 100 to 50 parts of an ionomer resin. However, when foam extrusion of such a mixture is carried out to prepare an open cell foam, the extrusion pressure is high, leading to severe heat generation at the die. This makes it very difficult to obtain good open cell extruded foams having a high expansion ratio and high thickness. In addition, stable manufacture is difficult because the foaming temperature must be regulated within a narrow range during extrusion foaming in order to obtain open cell extruded foam.

WO 02/27905 teaches that ionomer present in a polyethylene resin at a level of from about 1 to about 40% by weight of the resin produces superior continuously extruded foam sheet products that approach the pore size and resiliency of foams prepared from chemical blowing agents.

WO 02/18482 discloses extruded polyolefin open cell foam, which exhibits uniform physical properties, high expansion ratio and uniform cell diameter. The base resin is principally composed of a mixed polymer consisting of 4.5 to 75 parts by weight of component A consisting of an ethylene ionomer resin, 0.5 to 30 parts by weight of component B consisting of a polyolefin resin having a melting point exceeding 120° C., and 20 to 95 parts by weight of component C consisting of one or two or more polymers selected from the group consisting of ethylene-propylene rubbers, styrene elastomers, and polyethylene resins having melting points of 120° C. or lower (where component A+component B+component C=100 parts by weight).

Japanese Patent Publication No. 56-55442 discloses a resin composition comprising a copolymer of ethylene and α,β-ethylenically unsaturated carboxylic acid and optionally an α,β-unsaturated ester, partially or completely ionically crosslinked by ions, and a polyamide resin having a melting point of not more than 160° C. Ten percent or more of the α,β-unsaturated carboxylic acid component is disclosed to be neutralized by Na⁺, Mg⁺², Zn⁺², Al⁺³ and the like.

U.S. Pat. No.4,766,174 discloses melt processible blends of aluminum ionomers of ethylene/α,β-ethylenically unsaturated carboxylic acid copolymers and thermoplastic resins or elastomers. From about 1 to about 100% of the carboxylic acid groups of the ethylene copolymer are neutralized with aluminum ions.

As described in the documents cited above, it has been very difficult to stably manufacture open cell extruded foam exhibiting high expansion ratio and high open cell foaming ratio using these ionomers alone or blends of these ionomers and polyolefin resins. Consequently, there is a substantial and continuing need in the art for open cell foam compositions with improved properties, i.e., high melt strength or melt tension and low flexural modulus, in order to achieve optimum processibility and extruded foam properties.

### SUMMARY OF THE INVENTION

The present invention addresses the above-described need by providing a foamed polymer-ionomer blend comprising: (a) at least one thermoplastic polymer selected from the group consisting of polyethylene and copolymers thereof, polypropylene and copolymers thereof, polybutene-1, poly(4-methylpentene-1), polystyrene and copolymers thereof, and (b) an ionomer resin comprising at least one direct or graft terpolymer prepared from: ethylene, α,β-ethylenically unsaturated carboxylic acid having from 3 to 8 carbon atoms, and softening comonomer selected from the group consisting of (A) vinyl ester of an aliphatic carboxylic acid wherein the acid has from 2 to 10 carbon atoms, (B) alkyl vinyl ether wherein the alkyl group contains from 1 to 10 carbon atoms, and (C) alkyl acrylate or alkyl methacrylate, wherein the alkyl group contains from 1 to 10 carbon atoms, and wherein the ionomer resin contains acid groups derived from the α,β-ethylenically unsaturated carboxylic acid that are at least partially neutralized with mono- or divalent metal ions.

The blends used in making the foam surprisingly possess a flexural modulus of less than about 20,000 psi while advantageously maintaining a melt tension of greater than about 10 cN at 220° C. Here, it should be noted that these properties are determined when evaluating the blend as described below. Thus, the blends of the present invention surprisingly possess a lower flexural modulus at a comparable melt tension, as compared with those polymer-ionomer blends lacking a softening comonomer in the ionomer, which blends have an undesirably higher flexural moduli than the blends of the invention. Accordingly, another aspect of the present invention is cell foam compositions containing the blends of the invention, which foam compositions advantageously possess the desired flex modulus and melt tension properties for forming a soft and flexible foam.

The foamed compositions of the present invention preferably have densities of from about 10 to about 200 kg/m³, preferably from about 20 to about 150 kg/m³. Preferably at least 50% of the foam cells are open cells.

Preferably the polymer-ionomer blend further comprises at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

The invention is also directed to a process comprising providing the at least one thermoplastic polymer, providing the ionomer resin, preparing a polymer-ionomer blend comprising the at least one thermoplastic polymer and the ionomer resin (the blend preferably can be measured to have a flexural modulus of less than about 20,000 psi and a melt tension of greater than about 10 cN at 220° C.), and foaming the blend to form a foamed polymer-ionomer blend. The foaming preferably comprises mixing the blend with a foaming agent to form a foaming molten resin mixture and extruding the foaming molten resin mixture through a die.

This invention is further directed to a multilayer article comprising at least one layer of the above-described foamed composition in contact with at least one layer of a superabsorbant polymer. In addition, the invention is directed to articles comprising the foam, such as those comprising a multilayer structure comprising at least one layer comprising the foam in contact with at least one layer of superabsorbant polymer. Examples include diapers, adult incontinence pads and sanitary napkins.

### DETAILED DESCRIPTION OF THE INVENTION

Applicants specifically incorporate the entire content of all cited references in this disclosure. Trademarks are shown in upper case. Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present).

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

As indicated above, the blends of the invention comprise at least one direct or graft ionomer terpolymer of ethylene, an α,β-ethylenically unsaturated carboxylic acid, and a softening comonomer selected from the group consisting of vinyl esters, alkyl vinyl ethers, and alkyl acrylates or methacrylates.

The direct or graft terpolymers of ethylene, α,β-ethylenically unsaturated carboxylic acid and softening comonomer and methods for their preparation have been described in the art in, for example, U.S. Pat. Nos. 3,264,272 and 4,766,174.

The α,β-unsaturated carboxylic acid of the ionomer contains from 3 to 8 carbon atoms. Preferably, it is selected from the group consisting of acrylic acid, methacrylic acid, maleic acid, fumaric acid, itaconic acid, and half esters of maleic, fumaric and itaconic acids. More preferably, the α,β-unsaturated carboxylic acid is acrylic or methacrylic acid, and still more preferably the acid is methacrylic acid.

The softening comonomer is preferably selected from vinyl esters, alkyl vinyl ethers, and alkyl acrylate or methacrylates. Accordingly, suitable softening monomers are, for example, vinyl acetate, butyl vinyl ether, methyl vinyl ether, methyl acrylate, methyl methacrylate, ethyl acrylate, ethyl methacrylate, butyl acrylate and butyl methacrylate. Preferably, the softening comonomer is an alkyl acrylate, alkyl methacrylate or alkyl vinyl ether, and more preferably the softening comonomer is butyl acrylate.

The ethylene content of the ionomer terpolymer is greater than about 30 weight percent, preferably greater than about 50 weight percent, and more preferably greater than about 60 weight percent of the terpolymer.

The direct or graft copolymers of ethylene, α,β-ethylenically unsaturated carboxylic acid and softening comonomer contain from about 5 to about 60 weight percent of softening comonomer, and about 1 to about 25 weight percent α,β-ethylenically unsaturated carboxylic acid, the remainder being ethylene. Preferably, they contain from about 5 to about 40 weight percent softening comonomer and from about 5 to about 15 weight percent unsaturated carboxylic acid, the remainder being ethylene such that the ethylene content is greater than about 50 weight percent.

In the ionomer resin used in the blends of the present invention from about 3 to about 70% of the carboxylic acid groups are neutralized with metal cations, preferably mono- or divalent cations. A preferable maximum neutralization level is about 60%, and a more preferable level about 55%. In the context of this disclosure, the percent neutralization data are presented using the assumption that each cation will react with the maximum number of carboxylic acid groups calculated from its ionic charge. That is, it is assumed, for example, that Mg⁺² and Zn⁺² will react with two, and that Na⁺ will react with one.

Monovalent cations, if present, are preferably selected from the group consisting of sodium, potassium, and lithium, and divalent cations, if present, are selected from the group consisting of zinc, magnesium and calcium. More preferably, the monovalent cation will be sodium, and the divalent cation will be zinc. Mono- and divalent ion sources are typically formates, acetates, hydroxides, nitrates, carbonates and bicarbonates.

In addition to the above-described ionomer terpolymers, the polymer-ionomer blends of the invention contain a thermoplastic polymer selected from the group consisting of polyethylene and copolymers thereof (e.g. ethylene-vinyl acetate copolymers), polypropylene and copolymers thereof (e.g. propylene-ethylene copolymers), polybutene-1, poly(4-methylpentene-1), polystyrene and copolymers thereof. A preferred blending polymer is polyethylene, and a more preferred blending polymer is linear, low-density polyethylene.

The polymer-ionomer blends of the invention preferably contain an amount of thermoplastic polymer that is from about 10 to about 90 weight percent, more preferably 15 to about 85 weight percent, and most preferably from about 25 to about 80 weight percent of the total weight of the blend. The ionomer is preferably present at a level of from about 90 to about 10 weight percent, more preferably from about 85 to about 15 weight percent, and most preferably from about 75 to about 20 weight percent of the total weight of the blend.

The polymer-ionomer blends may further comprise at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber (EPDM).

Blends of ionomer, thermoplastic polymer(s) and any optional ingredients can be prepared by mixing the ionomer and polymer(s) at a temperature in the range from about 150° C. to about 300° C., preferably from about 180° C. to about 295° C., and most preferably from about 200° C. to about 290° C. Alternatively, the thermoplastic polymer may be blended with the unneutralized ethylene acid copolymer (the ionomer precursor), and then the resulting blend can be treated with the neutralizing ion sources. In yet another alternative procedure, the mixing of the polymers and neutralization may be carried out simultaneously.

The blends of the present invention surprisingly possess a flexural modulus of less than about 20,000 psi while advantageously maintaining a melt tension of greater than about 10 cN at 220° C.

Thus, the blends of the present invention surprisingly possess a lower flexural modulus at a comparable melt tension, as compared with those polymer-ionomer blends lacking a softening comonomer in the ionomer resin, which blends have an undesirably higher flexural moduli, as compared with the blends of the invention.

The blends of the present invention are particularly useful in preparing extruded foams. Without being limited to any particular theory, it is believed that the surprisingly improved properties, e.g. high melt tension and low flexural modulus, of the polymer-ionomer blends lead to substantially improved processing conditions for preparation of extruded foams having a low flexural modulus when compared to polymer-ionomer blends based on ionomer containing no softening comonomer.

The foamed compositions of the present invention can be obtained by mixing the blends of the invention having the desired properties discussed above, together with any additives used to control foam properties, supplying these to an extruder, subjecting these materials to melting under heating and kneading, then supplying a foaming agent and forming a foaming molten resin mixture, then regulating processing parameters such as the extrusion temperature, pressure inside the extrusion die, discharge volume, etc., as is well known in the art, and extruding the mixture from the die into a low pressure region and causing foaming. For mixing the components, methods known in the art can be utilized, such as dry blending the mixture components or using a screw feeder or the like, to introduce each of the mixture components from a raw material supply port and mixing them together inside the extruder. By selecting the die attached to the tip of the extruder according to the shape of the foam desired, extruded foam of various shapes can be manufactured.

The foaming agents used in the manufacture of the foams of the present invention can be either physical foaming agents or decomposing-type chemical foaming agents, but the use of physical foaming agents is preferred in order to obtain extruded open cell foam. For physical foaming agents, low boiling hydrocarbons such as propane, n-butane, isobutane, n-pentane, isopentane, n-hexane, cyclohexane, etc., chlorinated hydrocarbons such as methyl chloride and ethyl chloride, fluorocarbons such as 1,1,1,2-tetrafluoroethane and 1,1-difluoroethane, and other materials such as carbon dioxide, nitrogen and water may be utilized. For decomposing-type foaming agents, azodicarbonamide and the like may be employed. The foaming agents can be used in mixtures of two or more, and a decomposing type may be used together with a physical type and thus serve to regulate cell diameter.

The extrusion temperature preferably will be within the range from about 100° C. to about 250° C. and more preferably from about 150° C. to about 230° C. When the extrusion temperature is below about 100° C., the elastic forces of the polymeric components will be too strong, and thus it may not be possible to obtain a foam with a high expansion ratio. When the temperature exceeds about 250° C., on the other hand, the foam may tend to shrink or giant cells may be produced. The foams of the invention may be open or closed cell foams or mixtures thereof, with densities of from about 10 to about 200 kg/m³, more preferably from about 20 to about 150 kg/m³. Preferably, about 50% of the foam cells in a foamed composition are open cells. The term “open cell” in this context means that the individual cells of the foam are in complete, unobstructed communication with adjoining cells. The cells in such substantially open celled foam structures have intercellular openings or “windows” that are large enough to permit ready fluid transfer from one cell to another within the foam structure. Preferably, the foams of the invention are substantially open cell foams.

The substantially open cell foams of the present invention are suitable for use in articles used for disposable product applications such as diapers, adult incontinence pads, sanitary napkins and the like. In such articles, open cell foams often are used in conjunction with a superabsorbent polymer that is present in contact with the open cell foam. The superabsorbent polymer may be present at the surface of the cell walls of the foam. Accordingly, this invention also provides a multilayer structure comprising at least one layer of the foam composition of the present invention in contact with at least one layer of a superabsorbent polymer. Preferably, in the foam composition in the multilayer structure at least 50% of the foam cells are open cells. The multilayer structure may comprise a layer of superabsorbent polymer between two layers of the extruded open cell foam. Examples of superabsorbent polymer are those based on sodium salts of poly(acrylic acid), such as AQUAKEEP J550 available from Absorbent Technologies, Inc. Preferred multilayer structures comprise preferred compositions described above.

This invention thus also provides articles described above comprising the foamed compositions of the present invention. The foregoing illustrates a number of suitable articles, which can be made using the foam compositions of the present invention. Skilled artisans can readily envision additional articles and applications without departing from the scope or spirit of the present invention.

The following examples are presented to more fully demonstrate and further illustrate various aspects and features of the present invention. As such, the showings are intended to further illustrate the differences and advantages of the present invention but are not to be construed as to limiting the scope thereof in any manner.

### EXAMPLES

In the following examples, Ionomer A was a terpolymer of ethylene, 9 weight % methacrylic acid and 23.5 weight % n-butyl acrylate with 51% of the methacrylic acid groups neutralized with Zn⁺² cations and having a measured melt index (190° C./2.16 kg weight) of 0.6. lonomer B was a copolymer of ethylene and 10.5 weight % methacrylic acid with 68% of the methacrylic acid groups neutralized with Zn⁺² cations and having a measured melt index (190° C./2.16 kg weight) of 1.1. Ionomer C was a copolymer of ethylene and 15 weight % methacrylic acid with 58% of the methacrylic acid groups neutralized with Zn⁺² cations and having a measured melt index (190° C./2.16 kg weight) of 0.7. The ionomers were prepared by procedures described in U.S. Pat. No.3,264,272, which is incorporated herein by reference.

The low density polyethylene (LDPE) utilized in the examples had a melt index (190° C./2.16 kg weight) of 1.1, density of 0.92, and melting point of 108° C. It is available as DUPONT 20 from E.I. du Pont de Nemours and Company.

The formulations shown in Table 1 below were compounded using a 30 mm WERNER & PFLEIDERER extruder. Extruder zones from the feed to the die were set at temperatures between 180° C. and 200° C. The materials were compounded at 10 pounds/hour using a screw speed of 150 RPM. The components were premixed by tumble mixing ingredients in a polyethylene bag and were then fed to the WERNER & PFLEIDERER extruder. Temperatures of the melt streams exiting the extruder were measured with a handheld thermocouple and were in the range of 220 to 230° C.

The flexural moduli of the materials were measured according to ASTM D790 on ⅛-inch thick bars that were die-cut from solid plaques formed by compression molding at 200° C. the pellets produced in the twin screw compounding operation.

The melt tension data were obtained using a GOFFERT RHEOTENS in connection with a KAYENESS GALAXY 5 CAPILLARY RHEOMETER. The cylindrical capillary die of the capillary rheometer had dimensions of 30 mm long with a diameter of 1 mm (L/D=30). A pre-heat dwell time of 5 minutes was used before beginning the melt tension test. For melt tension testing, the materials were dried for 18 hours at 50° C. They were then tested for melt strength by extruding a melt strand of the polymer at 220° C. through the 30 L/D capillary die. The strand was extruded through the die using a constant head speed on the capillary rheometer of 6.35 mm/min while the take-up speed of the RHEOTENS equipment was varied from 0 to 120 cm/s.

Average melt tension (a measure of melt strength) data were recorded as the maximum force required to break the molten polymer strand. The maximum draw ratio of the strand was also recorded at this failure point defined as the ratio of the take-up speed to the strand extrusion speed.

The data are presented in Table 1.

TABLE 1
Flexural Modulus, Melt Tension, and Melt Draw Properties

| | Example No. | | | | | | | | | |
|---|---|---|---|---|---|---|---|---|---|---|
| | 1 | 2 | 3 | Comp 4 | Comp 5 | Comp 6 | Comp 7 | Comp 8 | Comp 9 | Comp 10 |
| | (wt %) | (wt %) | (wt %) | (wt %) | (wt %) | (wt %) | (wt %) | (wt %) | (wt %) | (wt %) |
| Material | | | | | | | | | | |
| Ionomer A | 20 | 40 | 60 | 0 | 0 | 0 | 0 | 0 | 0 | 0 |
| Ionomer B | 0 | 0 | 0 | 0 | 20 | 40 | 60 | 0 | 0 | 0 |
| Ionomer C | 0 | 0 | 0 | 0 | 0 | 0 | 0 | 20 | 40 | 60 |
| LDPE | 80 | 60 | 40 | 100 | 80 | 60 | 40 | 80 | 60 | 40 |
| Tests | | | | | | | | | | |
| Flexural | 19 | 15 | 11 | 23 | 26 | 30 | 33 | 29 | 35 | 40 |
| Modulus | | | | | | | | | | |
| (ksi) | | | | | | | | | | |
| Melt | | | | | | | | | | |
| Tension at | | | | | | | | | | |
| 220° C. | | | | | | | | | | |
| Avg. | 10.9 | 10.5 | 12.8 | 8.73 | 10.8 | 11.8 | 10.8 | 10.8 | 10.7 | 8.6 |
| Tension | | | | | | | | | | |
| (cN) | | | | | | | | | | |
| Max Draw | 48.18 | 68.47 | 86.22 | 50.72 | 55.79 | 65.94 | 88.76 | 53.26 | 60.86 | 98.9 |
| (%) | | | | | | | | | | |

The data presented in Table 1 demonstrate the effectiveness of incorporating ionomers that contain a third comonomer, in addition to ethylene and unsaturated carboxylic acid, into polyolefin blends to obtain high melt strength and low flexural modulus. The data show that by blending Ionomer A into a LDPE, a blend was formed that not only has excellent melt tension properties but also has a low flexural modulus. Data from Examples 1, 2, and 3 of the present invention shows that these blends have flexural moduli less than 20,000 psi while maintaining melt tension values of greater than 10 cN at 220° C. The Comparative Examples 5 through 10 posses melt tension values of greater than 10 cN at 220° C. However, none of the Comparative Examples achieved this level of melt strength while also maintaining a low flexural modulus (less than 20,000 psi), which is necessary for producing a soft and flexible foam.

The foregoing disclosure of embodiments of the present invention has been presented for purposes of illustration and description. It is not intended to be exhaustive or to limit the invention to the precise forms disclosed. Many variations and modifications of the embodiments described herein will be well within the skill of one of ordinary skill in the art in light of the disclosure.

1. A foam comprising a foamed polymer-ionomer blend comprising:
(a) at least one thermoplastic polymer selected from the group consisting of polyethylene and copolymers thereof, polypropylene and copolymers thereof, polybutene-1, poly(4-methylpentene-1), polystyrene and copolymers thereof, and
(b) an ionomer resin comprising at least one direct or graft terpolymer prepared from:
(1) ethylene,
(2) α,β-ethylenically unsaturated carboxylic acid having from 3 to 8 carbon atoms, and
(3) softening comonomer selected from the group consisting of (A) vinyl esters of aliphatic carboxylic acids wherein the aliphatic carboxylic acid has from 2 to 10 carbon atoms, (B) alkyl vinyl ethers wherein the alkyl group contains from 1 to 10 carbon atoms, and (C) alkyl acrylates or alkyl methecrylates wherein the alkyl group contains from 1 to 10 carbon atoms, and
wherein the ionomer resin contains acid groups derived from the α,β-ethylenically unsaturated carboxylic acid that are at least partially neutralized with mono- or divalent metal ions.

2. The foam of claim 1 wherein the blend has a flexural modulus of less than about 20,000 psi and a melt tension of greater than about 10 cN at 220° C.

3. The foam of claim 1 wherein the unsaturated carboxylic acid content of the ionomer resin is from about 1 to about 25 weight %, the softening comonomer content of the ionomer resin is from about 5 to about 60 weight %, and the ethylene content of the ionomer resin is greater than about 30 weight %, and further wherein the acid groups derived from the α,β-ethylenically unsaturated carboxylic acid are from about 3 to about 70% neutralized with metal ions.

4. The foam of claim 1 having a density of from about 10 to about 200 kg/m³.

5. The foam of claim 4 wherein the density is from about 20 to about 150 kg/m³.

6. The foam of claim 1 wherein the foam comprises foam cells and at least about 50% of the foam cells are open cells.

7. The foam of claim 1 wherein the softening comonomer is an alkyl acrylate.

8. The foam of claim 7 wherein the alkyl acrylate is butyl acrylate.

9. The foam of claim 1 wherein the thermoplastic polymer is polyethylene.

10. The foam of claim 8 wherein the thermoplastic polymer is polyethylene.

11. The foam of claim 9 wherein the thermoplastic polymer is linear, low density polyethylene.

12. The foam of claim 1 wherein the polymer-ionomer blend further comprises at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

13. A process of preparing a foam comprising:
(a) providing at least one thermoplastic polymer selected from the group consisting of polyethylene and copolymers thereof, polypropylene and copolymers thereof, polybutene-1, poly(4-methylpentene-1), polystyrene and copolymers thereof, and
(b) providing ionomer resin comprising at least one direct or graft terpolymer prepared from:
(1) ethylene,
(2) α,β-ethylenically unsaturated carboxylic acid having from 3 to 8 carbon atoms, and
(3) softening comonomer selected from the group consisting of (A) vinyl esters of aliphatic carboxylic acids wherein the aliphatic carboxylic acid has from 2 to 10 carbon atoms, (B) alkyl vinyl ethers wherein the alkyl group contains from 1 to 10 carbon atoms, and (C) alkyl acrylates or alkyl methacrylates wherein the alkyl group contains from 1 to 10 carbon atoms, and
wherein the ionomer resin contains acid groups derived from the α,β-ethylenically unsaturated carboxylic acid that are at least partially neutralized with mono- or divalent metal ions;
(c) preparing a polymer-ionomer blend comprising the at least one thermoplastic polymer and the ionomer resin, wherein the blend has a flexural modulus of less than about 20,000 psi and a melt tension of greater than about 10 cN at 220° C.;
(d) foaming the blend to form a foamed polymer-ionomer blend.

14. The process of claim 13 wherein foaming comprises mixing the blend with a foaming agent to form a foaming molten resin mixture and extruding the foaming molten resin mixture through a die.

15. The process of claim 14 wherein the foaming agent is selected from the group consisting of propane, n-butane, isobutane, n-pentane, isopentane, n-hexane, cyclohexane, methyl chloride, ethyl chloride, 1,1,1,2-tetrafluoroethane, 1,1-difluoroethane, carbon dioxide, nitrogen, water, and azodicarbonamide, and mixtures thereof.

16. A multilayer structure comprising at least one layer of the foam of claim 1 in contact with at least one layer of a superabsorbant polymer.

17. The multilayer structure of claim 16 wherein the foam has a density of from 10 to about 200 kg/m³, and wherein the foam comprises foam cells and at least 50% of the foam cells are open cells.

18. The multilayer structure of claim 16 wherein the polymer-ionomer blend further comprises at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

19. An article comprising the foam of claim 1.

20. The article of claim 19 comprising a multilayer structure comprising at least one layer comprising the foam In contact with at least one layer of superabsorbant polymer.

21. The article of claim 20 that is selected from the group consisting of diapers, adult incontinence pads and sanitary napkins.
